(19) United States
(12) Patent Application Publication
(10) Pub. No.: US 2020/0158502 A1
(43) Pub. Date: May 21, 2020

(54) SURFACE MEASURING DEVICE AND SURFACE MEASURING METHOD

(71) Applicant: CHROMA ATE INC., Tao-Yuan City (TW)

(72) Inventors: Cheng-Ting TSAI, Tao-Yuan City (TW); Lan-Sheng YANG, Tao-Yuan City (TW)

(21) Appl. No.: 16/683,226

(22) Filed: Nov. 13, 2019

(30) Foreign Application Priority Data
Nov. 16, 2018 (TW) 107140914

(51) Int. Cl. G01B 13/22; G01B 9/02

(52) U.S. Cl. CPC G01B 13/22; G01B 9/02024

(57) ABSTRACT

A measuring device used to measure a surface of an object is provided. The measuring system includes an air-flow generator, a light emitting device, and a light sensor. The airflow generator is located above the object, and is configured to inject a vapor flow onto the surface of the object and generates a condensing layer on the surface of the object. The light emitting device is located above the object and faces the condensing layer, and is configured to project a light towards the condensing layer. The light sensor is located above the object, and is configured to receive the light scattered by the condensing layer.

### RELATED APPLICATIONS

This application claims priority to Taiwan Application Serial Number 107140914, filed Nov. 16, 2018, which are herein incorporated by reference.

### BACKGROUND

### Field of Invention

The present disclosure relates to a surface measuring device and a surface measuring method.

### Description of Related Art

With the advancement of technology, more and more electronic products use transparent materials (e.g., glass or acrylic) as product components (e.g., mobile phone panels, mobile phone cases or lenses). In order to ensure quality, the product components can be measured by a measuring device to obtain their surface topography. However, measuring transparent components has technical difficulties. For example, the transparent material has a low reflectivity. To measure a sufficiently accurate transparent component image, it is necessary to increase the exposure time or light source intensity of the transparent component. If the interior or surface of the transparent component has sputum or particles measured by a measurement device, it may cause a wrong result about misjudged signal. In addition, if the surface of the transparent component is a curved surface, it is easy to be affected by a deviation of the surface of the object to be measured by the inclination of the surface of the object to be measured, which leads to a situation in which the height measurement is misjudged.

With the above technical problems, the prior art attempts to use a coordinate measuring machine and spray non-transparent particles (e.g., titanium dioxide particles) to attempt to reconstruct the three-dimensional topography of the product components. However, the time and money cost of the coordinate measuring machine is too high, and spraying non-transparent particles is easy to damage the product component body. Therefore, people in the field want to find a lower cost, fast and effective measurement of product components.

### SUMMARY

According to an embodiment of the present disclosure, a surface measuring device is used to measure a surface of an object. The surface measuring device includes an airflow generator, a light emitting device and a light sensor. The airflow generator is configured to inject a vapor flow onto the object and generating a condensing layer on the surface of the object. The light emitting device is configured to project a light toward the condensing layer. The light sensor is located on the object and configured to receive the light scattered by the condensing layer.

In some embodiment, the airflow generator further includes a temperature regulator, a humidity regulator and a wind speed regulator. The temperature regulator is configured to control a temperature of the vapor flow. The humidity regulator configured to control a humidity of the vapor flow. The wind speed regulator is configured to control a wind speed of the vapor flow.

In some embodiment, an included angle between a direction of the vapor flow generated by the airflow generator and a direction of the light generated by the light emitting device is an acute angle.

In some embodiment, the condensing layer further includes a plurality of water particles. Each of the water particles has a radius ranging from 0.1 μm to 100 μm.

According to another embodiment of the present disclosure, a surface measuring device is used to measure a surface of an object. The surface measuring device includes an airflow generator, a platform, a light emitting device and a light sensor. The airflow generator is configured to inject a vapor flow. The platform is configured under the airflow generator to support the object. The platform is used to transfer the object through the airflow generator, and a condensing layer is formed on the surface of the object. The light emitting device is located on the platform and configured to project a light toward the condensing layer. The light sensor is located on the platform and configured to receive the light scattered by the condensing layer.

In some embodiment, the airflow generator further includes a temperature regulator, a humidity regulator and a wind speed regulator. The temperature regulator is configured to control a temperature of the vapor flow. The humidity regulator configured to control a humidity of the vapor flow. The wind speed regulator is configured to control a wind speed of the vapor flow.

In some embodiment, the platform further includes a moving member. The moving member is configured to move the object below the airflow generator at a first time, and the moving member is configured to move the object below the light emitting device at a second time.

In some embodiments, there is no cooling device at a first location during the first time. The first location is located on the platform.

According to an embodiment of the present disclosure, a surface measuring method is used to measure a surface of an object through a platform having a moving member to transfer the object. The surface measuring method includes following steps. Inject a vapor flow onto the surface to form a condensing layer on the surface by using the airflow generator. Project a light toward the condensing layer by using the light emitting device. Receive the light scattered by the condensing layer by using a light sensor.

In some embodiment, the surface measuring method further includes following steps. Control a temperature and a humidity of the vapor flow to causing a dew point of the vapor flow to be higher than a temperature of the object. Control a wind speed of the vapor flow.

In some embodiment, the light scattered by the condensing layer is a light of Mie scattering.

In summary, the surface measuring method and the surface measuring device proposed in the present disclosure have many advantages over the prior art. Firstly, the surface of the object to be measured is shielded by the condensing layer, so that the surface measuring method and the surface measuring device can measure the transparent object, thereby effectively preventing the light from penetrating the object and causing the photosensitive element to receive a large amount of background noise. Secondly, by controlling the particle size of the liquid particles in the condensing layer and selecting the light of the appropriate wavelength, the light is scattered by the condensing layer, so that the surface measuring method and the surface measuring device can measure the surface with the bending. Effectively avoiding the problem that the photosensitive element cannot receive the signal because of the light excessively deflected on the bent surface.

### BRIEF DESCRIPTION OF THE DRAWINGS

FIG. 1 is a flowchart of a surface measuring method according to one embodiment of the present disclosure;

FIG. 2A is a side view of a surface measuring device used for the surface measuring method in one step;

FIG. 2B is a side view of the surface measuring device used for the surface measuring method in another step;

FIG. 2C a side view of the surface measuring device used for the surface measuring method in another step;

FIG. 3 is a block diagram of an airflow generator device according to one embodiment of the present disclosure;

FIG. 4 is a graph illustrating interference phenomenon between wavelengths of light and particle sizes of liquid particles in a condensing layer.

FIG. 5 is a schematic view of a surface measuring device according to another embodiment of the present disclosure; and

FIG. 6 is a schematic view of a surface measuring device according to another embodiment of the present disclosure.

### DETAILED DESCRIPTION

The following embodiments are disclosed with accompanying diagrams for detailed description. For illustration clarity, many details of practice are explained in the following descriptions. However, it should be understood that these details of practice do not intend to limit the present invention. That is, these details of practice are not necessary in parts of embodiments of the present invention. Furthermore, for simplifying the drawings, some of the conventional structures and elements are shown with schematic illustrations. Also, the same labels may be regarded as the corresponding components in the different drawings unless otherwise indicated. The drawings are drawn to clearly illustrate the connection between the various components in the embodiments, and are not intended to depict the actual sizes of the components.

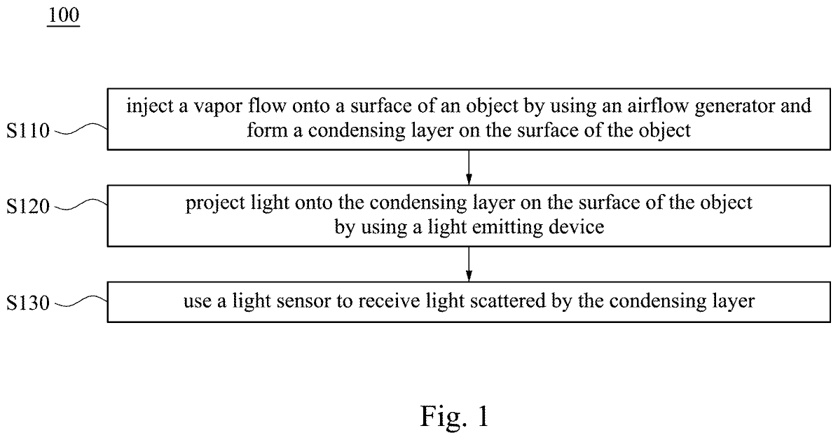

Please refer to FIG. 1. FIG. 1 is a flowchart of a surface measuring method 100 according to one embodiment of the present disclosure. As illustrated in FIG. 1, the surface measuring method 100 includes steps S110, S120 and S130. The surface measuring method 100 can be used to measure a contour of a surface of an object.

As illustrated in FIG. 1, the surface measuring method 100 starts from step S110. Step S110 is to inject a vapor flow onto a surface of an object by using an airflow generator and form a condensing layer on the surface of the object. Then, continue to step S120. Step S120 is to project light onto the condensing layer on the surface of the object by using a light emitting device. Finally, go to step S130. Step S130 is to use a light sensor to receive light scattered by the condensing layer. In some embodiments, the light sensor transmits the received light signals to a processor. The processor can translate the signals to the contour of the surface of the object.

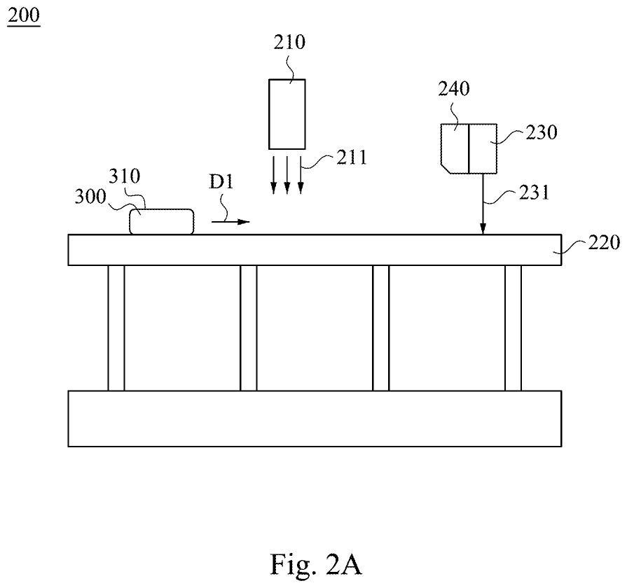

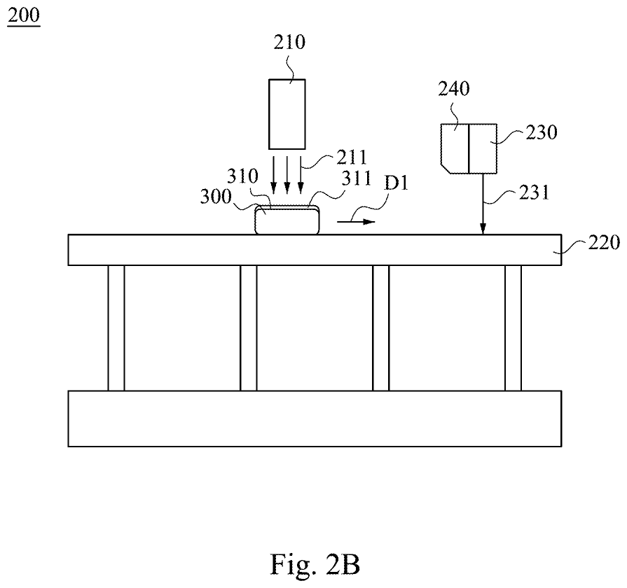

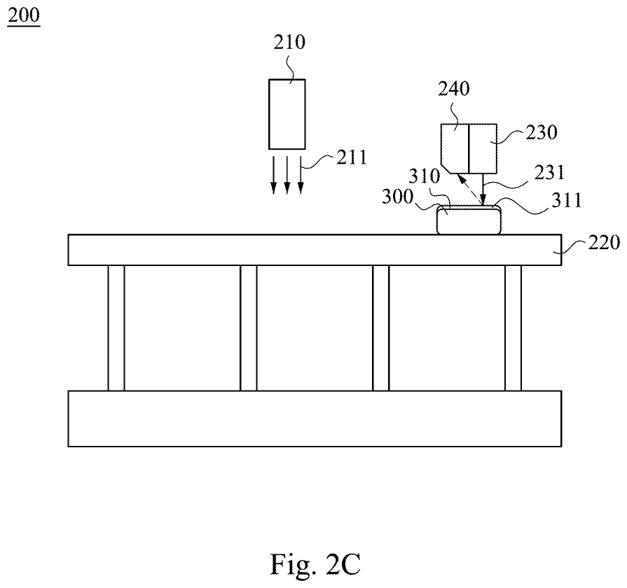

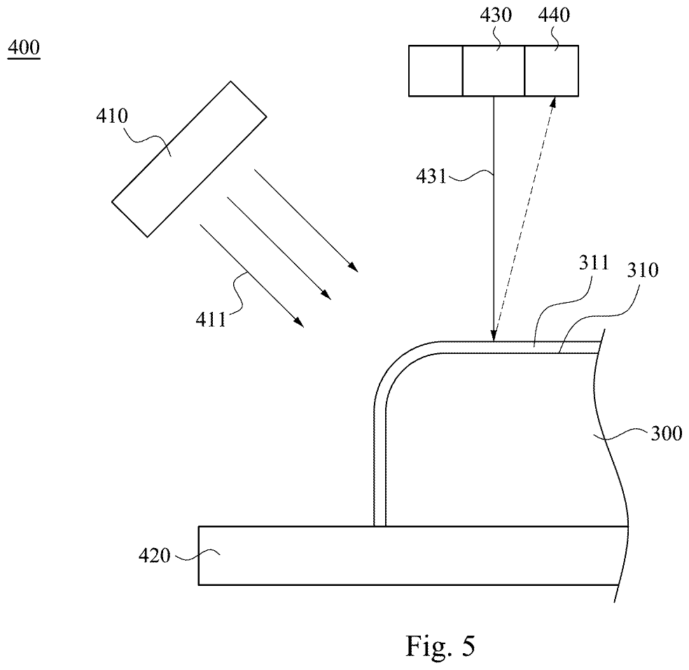

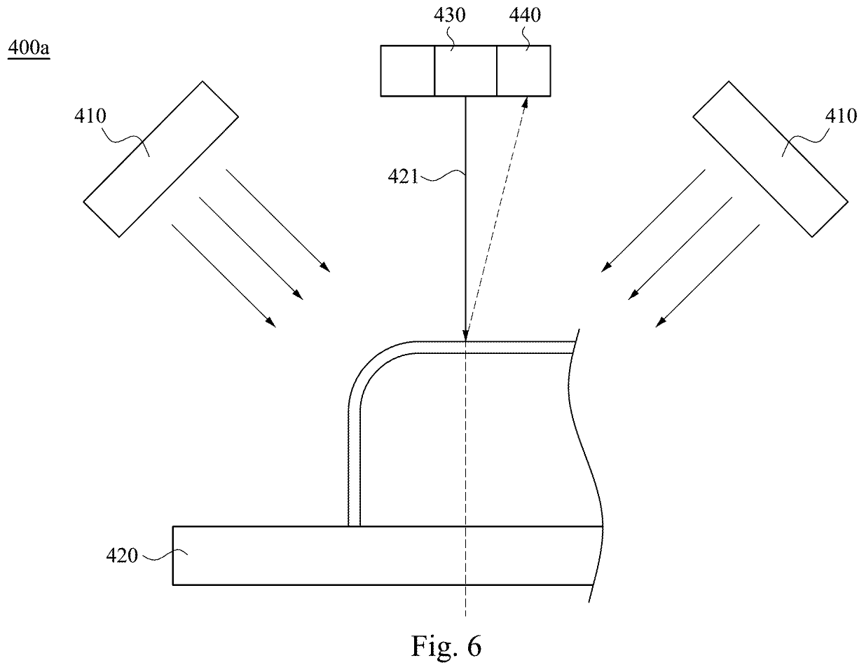

A specific configuration of each device employed in the surface measuring method 100 will be described later with reference to the drawings. For the purpose of explanation, please refer to FIGS. 2A, to 2C, which respectively illustrate side views of a surface measuring device 200 employed in the surface measuring method 100 at various steps. It should be understood that the surface measuring method 100 can be combined with various surface measuring devices (for example, as shown in FIGS. 5 and 6). For the sake of convenience of explanation, the surface measuring device 200 in FIGS. 2A to 2C is taken as an example but not limited to the present disclosure.

As illustrated in FIG. 2A, the surface measuring device 200 is used to measure an object 300. The surface measuring device 200 includes an airflow generator 210, a platform 220, a light emitting device 230 and a light sensor 240. The airflow generator 210 is configured to inject a vapor flow 211. The platform 220 is located under the airflow generator 210 and configured to support the object 300. In addition, the platform 220 can move the object 300. The light emitting device 230 is located on the platform 220 and configured to project light 231 to the platform 220. The light sensor 240 is located on the platform 220 and configured to receive light.

In this embodiment, the platform 220 can have a moving member. The moving member can be located under the airflow generator 210 and the light emitting device 230. The object 300 is at a position above the moving member. As illustrated in FIGS. 2A to 2C, the moving member can move the object 300 along a direction D1 from the airflow generator 210 to the light emitting device 230. That is, the object 300 will sequentially pass under the airflow generator 210 and under the light emitting device 230. Specifically, at a first time, users can place the object 300 in a first location (as shown in FIG. 2A). Then, at a second time, the moving member of the platform 220 transfers the object 300 to a position between the airflow generator 210 and the platform 220 (as shown in FIG. 2B). Finally, at the third time, the platform 220 transfers the object 300 to a position between the light emitting device 230 and the platform 220 (as shown in FIG. 2C). In some embodiments, the moving member can include a motor, a gear and a conveyor belt.

As illustrated in FIG. 2B, when the object 300 is transferred between the airflow generator 210 and the platform 220, a vapor flow 211 injected by the airflow generator 210 contacts the surface 310 of the object 300, and a condensing layer 311 is formed over the surface 310. The surface 310 faces toward the airflow generator 210. In this embodiment, the vapor flow 211 injected by the airflow generator 210 is perpendicular to the platform. Therefore, the vapor flow 211 can contact the surface 310 uniformly.

In this embodiment, the airflow generator 210 can be various devices that generate airflow (such as a fan, a pneumatic pump, etc.) and configured to manufacture gas convection near the surface 310 of the object 300. After the vapor flow 211 contacts the surface 310, a portion of the vapor in the vapor flow 211 condenses above the surface 310 and form a plurality of liquid particles, which in turn constitute the condensing layer 311.

In this embodiment, the vapor flow 211 includes water steam. After the vapor flow 211 contacts the surface 310, the water steam in the vapor flow 211 condenses into liquid water droplets, and the water droplets form the condensing layer 311. In other embodiments, the vapor flow 211 can also include vapors of different materials. In some embodiments, substances (such as water, inert particles, micro-metal particles, etc.) that have less influence on the object 300 can be used. Alternatively, a substance which is more easily removed from the surface 310 of the object 300, such as various organic solvents (e.g., methyl ether, ethanol, etc.) can be used.

In this embodiment, there is no cooling device at the first location during the first time to the second time. That is, at the first location, the object 300 do not require additional cooling, and the condensing layer 311 can still be formed over the surface 310 of the object 300. Specifically, it is only necessary to monitor the ambient temperature and adjust the parameters of the airflow generator 210 (e.g., the humidity and the temperature of the vapor flow 211) to achieve the effect of generating a condensing layer 311 on the surface 310 of the object 300. In the absence of a cooling device, the time taken for the entire surface detecting method 100 is saved.

In this embodiment, in addition to the different materials to form the condensing layer 311, the airflow generator 210 can adjust a temperature and pressure of the vapor flow 211, thereby controlling the properties of the condensing layer 311. For example, the properties of the condensing layer 311 include a number of the liquid particles, distribution of liquid particles and particle sizes of each liquid particle (e.g., radius of the particles), and the like.

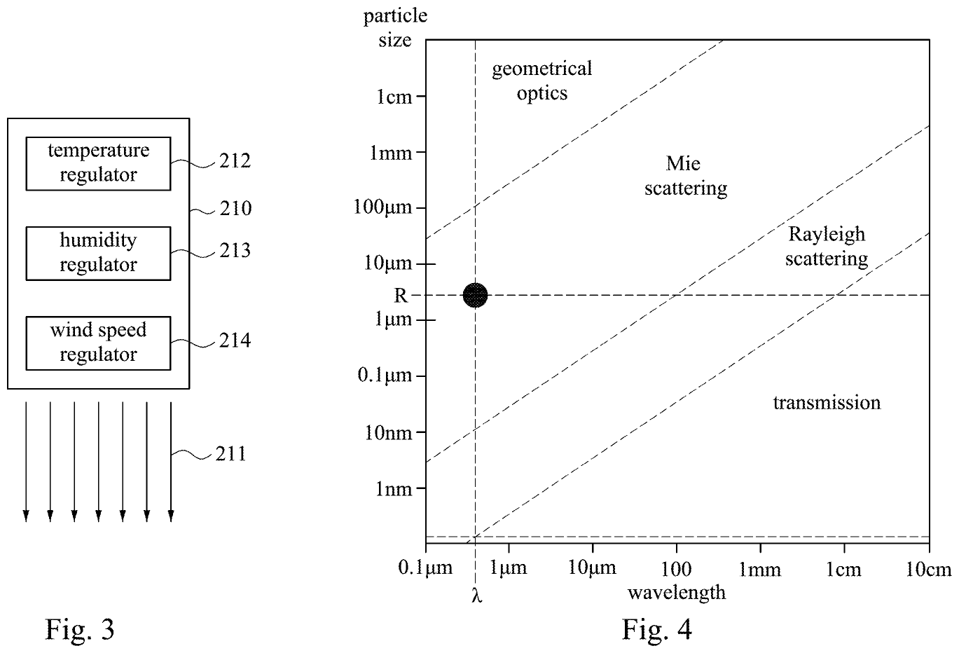

Specifically, please refer to FIG. 3. FIG. 3 illustrates a block diagram of an airflow generator 210 according an embodiment of this disclosure. The airflow generator 210 can includes a temperature regulator 212, a humidity regulator 213 and a wind speed regulator 214. The temperature regulator 212 is configured to control a temperature of the vapor flow 211. The humidity regulator 213 is configured to control humidity of the vapor flow 211. The wind speed regulator 214 is configured to control wind speed of the vapor flow 211.

In some embodiments, the temperature regulator 212 can include a heater. The heater is configured to increase the temperature of the vapor flow 211. Specifically, the temperature of the vapor flow 211 is larger than a temperature of the surface 310 of the object 300. Through the structure above, when the vapor flow 211 contacts the surface 310, the temperature of the vapor flow 211 is reduced by the surface 310, and the vapor in the vapor flow 211 is more easily condensed into liquid particles and attached to the surface 310. It can effectively increase the formation rate of liquid particles of the condensing layer 311.

In some embodiments, the humidity regulator 213 can include an evaporator such that the pressure of a particular substance in vapor flow 211 is greater than the pressure of that particular substance in the environment. In this embodiment, the humidity regulator 213 evaporates the liquid water so that the humidity of the vapor flow 211 is increased. Since the vapor flow 211 includes a relatively high humidity, the vapor in the vapor flow 211 is more likely to condense into liquid particles and attached to the surface 310, and the formation rate of the liquid particles in the condensing layer 311 can be effectively increased.

In some embodiments, the temperature and humidity of the vapor flow 211 can be respectively controlled by the temperature regulator 212 and the humidity regulator 213, so that the dew point temperature of the vapor flow 211 is larger than the temperature of the object 300. Therefore, the condensing layer 311 is formed on the surface 310 of the object 300.

In some embodiments, the wind speed regulator 214 can include a fan. By adjusting the rotating speed of the fan, the wind speed of the vapor flow 211 can be adjusted. When the flow rate of the vapor flow 211 is large, convection of the vapor flow 211 near the surface 310, and thereby the formation and evaporation rate of the liquid particles in the condensing layer 311 are affected. In some embodiments, the wind speed regulator 214 can also include an airflow integration module such that the vapor flow 211 exits the airflow generator 210 with a uniform flow rate throughout, thereby controlling the distribution of liquid particles on the surface 310.

As described in paragraph above, by using the temperature regulator 212, the humidity regulator 213 and the wind speed regulator 214 of the airflow generator 210 to adjust the properties of the vapor flow 211, the formation rate of the liquid particles in the condensing layer 311 can be change. In this case, it is only necessary to control the time at which the vapor flow 211 contacts the surface 310 and the amount of liquid particles in the condensing layer 311 and the particle size can be controlled.

For example, the longer the object 300 remains under the airflow generator 210, the greater the number of liquid particles in the condensing layer 311 and the larger the particle size of the liquid particles of the condensing layer 311. In this embodiment, the time at which the object 300 remains below the airflow generator 210 can be determined only by controlling the speed at which the moving member of the platform 220 moves the object 300. In some embodiments, the time during which the vapor flow 211 contacts the surface 310 can also be controlled by turning the airflow generator 210 on and off.

Please refer to FIG. 2C, the moving member of the platform 220 transfers the object 300 to a position below the light emitting device 230. The light emitting device 230 projects light 231 to the object 300. The incident light 231 entering the condensing layer 311 interferes with the liquid particles in the condensing layer 311, causing the light 231 to change the transmission direction. In this embodiment, the direction in which the light 231 exits the condensing layer 311 is different from the direction in which the light 231 is incident on the condensing layer 311. Then, a part of the light 231 is received by the light sensor 240 after leaving the condensing layer 311.

In this embodiment, by controlling the particle sizes of the liquid particles in the condensing layer 311, the interference phenomenon that occurs when the light 231 is incident on the condensing layer 311 can be controlled. Specifically, the interference phenomenon can be transmission, reflection, refraction or scattering, and the like.

Specifically, please refer to FIG. 4. FIG. 4 is a graph illustrating interference phenomenon between wavelengths of light and particle sizes R of liquid particles in the condensing layer 311. In this embodiment, the light 231 emitted by the light emitting device is violet light having a wavelength A of about 405 nm. As illustrated in FIG. 4, an example is that the wavelength A of the light 231 is about 405 nm. When the particle sizes R of the liquid particles in the condensing layer 311 is less than about 10 nm, Rayleigh scattering occurs in the light 231. When the particle sizes R of the liquid particles in the condensing layer 311 ranges about 10 nm to 100 μm, the light 231 undergoes Mie scattering. When the particle sizes R of the liquid particles in the condensing layer 311 is larger than about 100 μm, the light 231 follows the general geometrical optics (e.g., reflection or refraction).

In this embodiment, by controlling the wavelength λ of the light 231 and the particle size R of the liquid particles in the condensing layer, Mie scattering occurs in the light 231 incident on the condensing layer 311. Specifically, the light 231 can be ultraviolet light, visible light or infrared light, and the particle sizes R of the liquid particles in the condensing layer 311 can be between about 0.1 μm and 100 μm. In some embodiments, the particle sizes R of the liquid particles can be controlled to about 4 μm, and the scattered light has uniform and high intensity, which can further improve the accuracy of the surface measuring device 200.

In some embodiments, the light emitting device 230 and the light sensor 240 are integrated into a module and are movable relative to the platform 220. That is, only the light 231 emitted by the light emitting device 230 is projected onto the surface 310 of the object 300 in FIG. 2C, but actually the light emitting device 230 and the light sensor 240 can be moved relative to the platform 220. The light 31 is swept over the entire range of the surface 310 of the object 300. Alternatively, the light emitting device 230 and the light sensor 240 may be fixed to the platform 220, but the light emitting device 230 can change the direction in which the light 231 is projected to the object 300, so that the light 231 sweeps over the entire range of the surface 310 of the object 300.

In this embodiment, when the light 231 is swept across the surface 310 of the object 300, the light sensor 240 can transmit the received light intensity signals to an outer processor, and the processor can rebuild the three-dimensional image information based on the light intensity signals. According to the rebuilding result, it can be determined whether the contour of the surface 310 of the object 300 is reasonable. Therefore, the surface measuring device 200 has successfully completed all the steps in the surface measuring method 100.

In summary, this disclosure provide a surface measuring method 100 used to measure the surface 310 of the object 300 and a surface measuring device 200 used to perform surface measuring method 100. After completing all the steps in the surface measuring method 100, the contour information of the surface 310 of the object 300 is provided.

Compared with prior arts, the surface measuring method 100 and the surface measuring device 200 have various advantages. First, the object 300 is covered by the condensing layer 311, so that the surface measuring method 100 and the surface measuring device 200 can measure the transparent object 300, effectively preventing the light 231 from penetrating the object 300 and being reflected by the platform 220, and it prevents the light sensor 240 receives a large amount of background noise caused by the reflection from the platform 220. Next, by controlling the particle sizes R of the liquid particles in the condensing layer 311 and selecting the light 231 of the appropriate wavelength λ, the light 231 and the condensing layer 311 are subjected to Mie scattering, and the surface measuring method 100 and the surface measuring device 200 can measure the object 300 having the bent surface 310. It effectively avoids the problem that the light 231 is excessively deflected on the bent surface 310 and the light sensor 240 cannot receive the signal. Finally, in the structure of the surface measuring device 200, multiple objects 300 can be continuously placed on the platform 220, and the surface measuring method 100 can be continuously executed, and a large number of objects can be measured under the condition of low time cost and low cost. 300. By contrast, conventional techniques can only measure object in a sampled manner.

As described above, the surface measuring device 200 is an example implementing surface measuring method 100. Those skilled in the art can design different systems to implement the surface measuring method 100 in accordance with practical needs. For example, please refer to FIG. 5. FIG. 5 is a schematic view of a surface measuring device 400 according to another embodiment of the present disclosure.

As illustrate in FIG. 5, the surface measuring device 400 is used to measure an object 300. The surface measuring device 400 includes an airflow generator 410, a platform 420, a light emitting device 430 and a light sensor 440. The platform 220 is configured to support the object 300. The airflow generator 410 is located on the object 300 and configured t0 inject a vapor flow 211 on the surface 310 of the object 300 and form a condensing layer 311 on the surface 310. The light emitting device 430 is located on the object and faces to the condensing layer 300, and the light emitting device is configured to project light 431 to the condensing layer 311. The light emitting device 440 is located on the object 300 and configured to receive the light 431 scattered by the condensing layer 311. The difference between the airflow generator 410 and the airflow generator 210 in FIG. 2A is that the direction in which the airflow generator 410 injects the vapor flow 411 is inclined relative to the platform 420 but not perpendicular to the platform 420. That is, in this embodiment, the direction of the vapor flow 411 is at an acute angle to the direction of the light 431 projected by the light emitting device 430.

The airflow generator 410 in FIG. 5 can further include the temperature regulator 212, the humidity regulator 213 and the wind speed regulator 214 illustrated in FIG. 3. For details, refer to the description of FIG. 3 above, which will not be repeated.

In addition, the light emitting device 430 and the light sensor 440 are respectively similar to the light emitting device 230 and the light sensor 240 in FIGS. 2A to 2C. In this embodiment, by the surface measuring method 200 above, the light 431 is injected to the condensing layer 311 and the Mie scattering occurs in the light 431. Therefore, the light 431 from the light emitting device 430 can be designed to be perpendicular to the platform 420, while sensor 440 receives light 431 in a direction that is not perpendicular to the platform 420.

The surface measuring device 400 in FIG. 5 can also be used to perform steps S110, S120 and S130 in FIG. 1. In step S130, the light sensor 440 can transmit received light signals to a processor, and the processor further translates the light signals in a three-dimension contour of the surface 310 of the object 300.

In summary, the surface measuring device 400 can be used to measure the transparent object 300 or to measure the object 300 having the curved surface 310. The object 300 in the surface measuring device 400 is placed on the platform 420, and it has the advantage of high stability. In addition, the surface measuring device 400 has a small volume, and it has the advantage of saving space.

In some embodiments, in order to further control the properties of the condensing layer 311 on the surface 310, various airflow generators 410 can be configured on the platform 420. Specifically, please refer to FIG. 6. FIG. 6 is a schematic view of a surface measuring device 400a according to another embodiment of the present disclosure.

As illustrated in FIG. 6, most of the devices included in the surface measuring device 400a are the same as the surface measuring device 400, with the difference that the surface measuring device 400a includes two airflow generators 410. The two airflow generators 410 are symmetric with respect to the normal 421 of the platform 420. That is, one of the airflow generators 410 has a first angle with the normal 421, and the other airflow generator 410 has a second angle with the normal 421, and the first angle is equal to the second angle.

The surface measuring device 400a can also be used to perform surface measuring method 100, and the flow of performing the surface measuring method 100 using the surface measuring device 400a is the same as that of the surface measuring device 400. Further, in addition to all the advantages of the surface measuring device 400, the surface measuring device 400a can control the properties of the condensing layer 311 in a more detailed manner since one airflow generator 410 is provided. For the remaining advantages, please refer to the previous paragraph, which will not be repeated.

Some embodiments of this disclosure have been described by the foregoing examples and embodiments, and it should be understood that this disclosure is not limited to the disclosed embodiments. On the contrary, the present invention is intended to include a variety of modifications and approximate designs (as would be apparent to those of ordinary skill in the art). Therefore, additional claims should be based on the broadest interpretation to include all such modifications and designs.

What is claimed is:

1. A surface measuring device used to measure a surface of an object, comprising:
a platform having a moving member used to transfer the object;
a first location on the platform, wherein the object is located on the first location at a first time;
an airflow generator configured to inject a vapor flow onto the object and generating a condensing layer on the surface of the object when the object moves to a position between the airflow generator and the platform by the moving member at a second time;
a light emitting device configured to project a light toward the condensing layer when the object is transferred to a position between the light emitting device and the platform by the moving member and the light emitting device faces to the condensing layer at a third time; and
a light sensor located on the object and configured to receive the light scattered by the condensing layer,
wherein there is no cooling device at the first location during the first time to the second time.

2. The surface measuring device of claim 1, wherein the airflow generator further comprises:
a temperature regulator configured to control a temperature of the vapor flow;
a humidity regulator configured to control a humidity of the vapor flow; and
a wind speed regulator configured to control a wind speed of the vapor flow.

3. The surface measuring device of claim 1, wherein an included angle between a direction of the vapor flow generated by the airflow generator and a direction of the light generated by the light emitting device is an acute angle.

4. The surface measuring device of claim 1, wherein the condensing layer further comprises:
a plurality of water particles, wherein each of the water particles has a radius ranging from 0.1 μm to 100 μm.

5. A surface measuring method used to measure a surface of an object through a platform having a moving member to transfer the object, comprising:
placing the object in a first location on the platform at a first time;
transferring the object to a position between an airflow generator and the platform through the moving member at a second time and injecting a vapor flow onto the surface to form a condensing layer on the surface by using the airflow generator;
transferring the object to a position between a light emitting device and the platform through the moving member at a third time and using the light emitting device to project a light toward the condensing layer; and
using a light sensor to receive the light scattered by the condensing layer,
wherein there is no cooling device at the first location during the first time to the second time.

6. The surface measuring method of claim 5, further comprising:
controlling a temperature and a humidity of the vapor flow to causing a dew point of the vapor flow to be higher than a temperature of the object; and
controlling a wind speed of the vapor flow.

7. The surface measuring method of claim 5, wherein the light scattered by the condensing layer is a light of Mie scattering.
